(19) United States
(12) Patent Application Publication
(10) Pub. No.: US 2026/0367260 A1
(43) Pub. Date: Nov. 19, 2026

(54) SYSTEM AND A METHOD FOR GAMMA RADIATION DOSE RATE MEASUREMENT

(71) Applicant: Spectral Labs Incorporated, San Diego, CA (US)

(72) Inventors: Rhett James Barnes, Escondido, CA (US); Bradley Harmon Frazer, Carlsbad, CA (US)

(73) Assignee: Spectral Labs Incorporated, San Diego, CA (US)

(21) Appl. No.: 19/210,277

(22) Filed: May 16, 2025

(51) Int. Cl. G01T 1/02; G01T 1/20

(52) U.S. Cl. CPC G01T 1/023; G01T 1/2006

(57) ABSTRACT

A method for measuring a dose rate of an ionizing radiation field and a system embodying the method comprising a compensation shield fully enclosing a scintillator and configured to modify the ionization radiation field that passes through the compensation shield to compensate for absorption efficiency and conversion efficiency of the scintillator; the scintillator configured to convert optimally absorbed energy of the modified ionizing radiation field into optical photons; at least one photodetector optically coupled to the scintillator configured to convert the optical photons into an output signal; and a processing electronic communicatively coupled to the at least one photodetector configured to determine the dose rate in accordance with the output signal measurement.

### BACKGROUND

### 1. Field

The present invention relates to design of a system and a method for monitoring radioactive emissions. More particularly, the present invention is directed toward a design of a system and a method which is capable of detecting gamma radiation and measuring an accurate dose rate of the gamma ionizing radiation.

### 2. Description of Related Technology

An important class of quantities used within the ionizing radiation measurement field is the radiation dose, which is useful in directly assessing medical effects and the amount of damage to tissues and other materials. Detecting and measuring such a radiation dose is important in many fields of human endeavor, such as occupational exposure level in medical, industrial, and nuclear power settings, exposure level to troops in the battlefield, experimental physics, and other environments known to a person of ordinary skill in the art. Additionally, measurement of a radiation dose rate provides useful data in high-energy physics, sterilization and food irradiation, as well as assessment of damage to equipment in harsh radiation environments such as space.

An ionizing radiation may be in a form of an electromagnetic radiation, e.g., high energy ultraviolet radiation, X-ray radiation, and gamma radiation, and in a form of a particle radiation, e.g., alpha particles, beta particles, and neutrons. The different forms of ionizing radiation may be described in terms of flows of photons - high energy ultraviolet radiation, X-ray radiation, and gamma radiation, or particles - alpha particles, beta particles, and neutrons. However, in order to avoid potentially awkward language constructions, the term “particle” will be used when referring to non-specific forms of an ionizing radiation, and the term “photon” will be used if reference to a specific form of an ionizing radiation is necessary to avoid ambiguity. The term photon being commonly understood to occur as quantized units of electromagnetic energy. Such a terminology is supported by quantum mechanics as exhibiting wave-particle duality, their behavior featuring properties of both waves and particles; Joos, George (1951). Theoretical Physics. London and Glasgow: Blackie and Son Limited. p. 679.

Within the field of ionizing radiation, it is well known that each such particle exists as a separate isolated entity, which can interact with a material exposed to the ionizing radiation in discrete individual events. It is also well known that each individual particle possesses a quantifiable energy, which was imparted upon the particle during its creation. This holds true both for particles with rest mass (in the terms of Einstein’s theory of special relativity), such as electrons as well as massless particles such as photons, cf., G. F. Knoll, Radiation Detection and Measurement, 4th ed (2010), p.3 John Wiley and Sons. Consequently, the term particle will be used unless there is a need to distinguish particles with rest mass and massless particles. The total particle energy or a portion thereof may be released into the material with various probabilities which are dependent both on the energy of the particle and the material itself.

The quantity radiation dose quantifies the total amount of energy deposited per unit mass, and equal to the sum of energies deposited into the interacting material by each individual particle’s interaction. As such, the radiation dose is a function of the number of particles interacting with the material and the energies of the individual particles. An ionizing radiation is often described in terms of a field - a number of particles, each particle with its own energy, and can be characterized by a distribution of energy among the number of particles (“spectrum”) and a flux, i.e., the total number of particles (of any energy), passing through an area over a given time. The quantity radiation dose rate quantifies the amount of a radiation dose per unit of time. The radiation dose rate thus depends on the number of particles and the energies of the individual particles interacting with the interacting material per unit of time.

It is also well understood that production and absorption of ionizing radiation is a stochastic process. The production of radiation particles is not deterministic because the production occurs irregularly with accompanying fluctuations in a radiation field. Similarly, the absorption of radiation is not deterministic and thus spans a range of potential absorbed energies. Consequently, the individual production and absorption events are only able to be predicted on a probability basis. However, for a suitably large number of events, production and absorption of ionizing radiation approach steady state values and may be accurately described by statistical averages. Therefore, wherein a quantitative value(s) of different ionization radiation properties are considered, it is understood that such value(s) are described in statistical terms.

One of the primary technologies employed for detection and measurement of ionizing radiation comprises a Geiger counter (also known as a Geiger–Müller counter or G-M counter). A Geiger counter is an electronic instrument used for detecting and measuring some forms of ionizing radiation, specifically X-ray radiation, gamma radiation, alpha particles, and beta particles. The Geiger counter can also be adapted to detect neutrons. The Geiger counter comprises a Geiger–Müller tube that is the sensing element that detects such an ionizing radiation, and processing electronic that processes the detected ionizing radiation and displays the result.

The Geiger–Müller tube is filled with an inert gas, e.g., helium, neon, or argon, optionally mixed with other gas(es), e.g., organic vapor or a halogen gas, to improve and/or modify the Geiger–Müller tube response to the ionizing radiation, e.g., an ability to respond linearly to increasing radiation field, minimizing noise, covering a specific dynamic range, and other improvements and/or modification known to one of ordinary skill in the art. The Geiger–Müller tube further comprises two electrodes disposed within the tube, between which a high voltage of several hundred volts is applied. Such design properties of the Geiger–Müller tube determine minimum particle energy causing the gas ionization, and, consequently, the minimum of the range of measurable ionization radiation.

When the tube is exposed to an ionizing radiation field, a particle thereof exceeding the minimum energy causes an ionization of the gas via a collision with the gas molecules. The high voltage further amplifies that ionization and the subsequent conduction by the mechanism of Townsend discharge effect, thus producing a detection pulse, which does not contain any information of the particle energy beyond that the minimum energy was exceeded. The Townsend discharge event must be fully extinguished prior to the Geiger–Müller tube being able to detect a subsequent particle through a subsequent Townsend discharge effect. Consequently, the Geiger–Müller tube’s output is inherently a series of discrete pulses, i.e., the Geiger–Müller tube operates in a pulse mode.

The detected pulse(s) are provided to a processing electronic, which generates and provides the high voltage for the Geiger–Müller tube and processes the detection pulse(s) to provide counts of detected ionization events over a unit of time. The counts thus comprise a number of ionization events detected; displayed either as a count rate, or as a total number of counts over a set time period.

Based on the foregoing, the counts of detected ionization events over a unit of time are proportional to only the flux of the ionizing radiation field reaching the detector. In other words, the measured count rate is generally independent of the distribution of particles’ energies within the flux. Consequently, all that the Geiger counter measures is flux and as such the output of the Geiger counter does not correlate to the ionizing radiation field’s dose rate, which depends on both the total flux as well as the energy distribution of particles within the ionizing radiation field.

The Geiger counter can be used to infer a measured radiation dose by utilizing a conversion factor scaling the count rate to a radiation dose rate, allowing for an indirect measurement of dose rate. To enable the Geiger–Müller tube to accurately measure a radiation dose for a range of particle energies, modifications must be performed to the Geiger-Müller tube to correct for variation in the dose absorbed in the Geiger-Müller tube due to different distribution of energies in the flux. By means of an example, consider that a Geiger counter is calibrated to an ionizing radiation source, producing a flux comprising particles of an energy, e.g., 100 keV/particle and all particle energy would be absorbed by the mass of a material. When the Geiger tube detects three such pulses per unit of time, the measured dose rate is 3 x 100 keV = 300 keV/unit time. However, should the Geiger counter be exposed to ionizing radiation source producing flux comprising particles of an energy, e.g., 300 keV/particle, and the Geiger tube detects one pulse per unit of time, since the Geiger counter is calibrated for 100 keV/particle, the reported measurement will be 1 x 100 keV = 100 keV per unit time, although the dose rate is 300 keV per unit time. In other words, the higher dose rate is underestimated by a factor of 3.

Since it is desirable that the Geiger counter accurately detects a range of ionizing radiation dose rate, the Geiger counter needs to be corrected over the range, so that each event represents an equal dose regardless of the particle energy. One approach to such per event energy correction is to incorporate an energy compensation shield to selectively attenuate radiation of particles with lower energies. This provides an equivalent energy per count irrespective of particle energy. Considering the example supra, a compensation shield may be designed such that two of three 100 keV photons are attenuated, while no 300 keV photons are attenuated by the compensation shield. In this case, each 100 keV photon is equivalent to 300 keV of energy incident upon the Geiger counter. For a Geiger counter employing a compensation shield, and calibrated in this manner for 300 keV photons, one pulse generated by an unattenuated 300 keV photon will now be an equivalent dose to the single pulse generated by three 100 keV photons incident on and attenuated by, the compensation shield. The count rate is equivalent to dose rate for both photon energies. The energy compensation shield comprises material absorbing radiation with magnitudes determined by the absorption properties of the material, the thickness of the material, the number of layers of different materials, and other design criteria known to a person of ordinary skill in the art.

Although perhaps the most used of the primary technologies, the Geiger–Müller tube has many disadvantages stemming from its construction. To wit, the two electrodes (anode and cathode) and thin connecting wires are enclosed in a vacuum enclosure with thin metal or glass, which are very fragile and prone to damage by shock or vibration. The lifespan is limited by degradation and consumption of the species within the gas or gas mixture and the gas or gas mixture leakage, typically yielding lifespan of less than a decade. The technology cannot exceed six decades of measurement ranges without advanced techniques, e.g., such techniques as dead-time compensation, time-to-count, and other techniques, known to a person of ordinary skill in the art, without which requires multiple tubes, e.g., tubes with different physical sizes and/or high voltages to cover the desired range.

The above-mentioned examples of the construction problems are further magnified by the rapidly shrinking supply chain due to industry’s move from production of tubes as electronic equipment to semiconductors, thus causing production companies unable to sustain a commercial production line, especially considering that multiple tubes for the desired measurement ranges are needed.

Another of the technologies used for radiation detection uses a scintillator. The scintillator is material that exhibits scintillation, i.e., absorption of an incident ionizing radiation and converting the absorbed energy into optical photons, i.e., photons with a wavelength in visible, infrared, and ultraviolet spectrum that can be directly detected by various optoelectronic sensors, e.g., photomultiplier tubes (PMTs), silicon photomultipliers (SiPMs), photodiodes, and other optoelectronic sensors known to a person of ordinary skill in the art.

At or below a predetermined rate of measured scintillation events (i.e. absorption of particles happens infrequently enough), the generated optical photons reach the optoelectronic sensor communicatively coupled to the scintillator, capable of capturing the generated optical photons in the form of discrete pulses. The predetermined rate of measured scintillation events is established by characteristics of the scintillator, e.g., size, absorption properties of the scintillator’s material, and other characteristics known to a person of ordinary skill in the art. Processing electronic communicatively coupled to the optoelectronic sensor process the discrete pulses to provide counts of the scintillation events. The counts thus comprise a number of scintillation events detected. These events can also be quantified as a count rate or as a total number of counts over a given time period. As such, apart from the different physics of the flux-to-pulse conversion, at or below the predetermined rate of measured scintillation events, the scintillator functions just like the Geiger counter pulse mode.

Unlike the Geiger counter, an absorption of particle in a scintillator generates a number of optical photons related to the incident particle’s energy. This scintillator’s property is known as a conversion efficiency. Furthermore, the scintillator may not absorb the total energy of an arbitrary source of ionizing radiation, i.e., only a fraction of the ionizing radiation incident on the scintillator may be absorbed by the scintillator either absolutely or partially, the reminder of the incident ionizing radiation may exit the scintillator without being absorbed. Absolute absorption means that the entire particle’s energy is absorbed, either via a single interaction event, or a via a succession of scattering interaction events, each scattering interaction event resulting in partial absorption; thus, the energy absorption efficiency is 100%. In contrast, partial absorption means that after a single interaction event or a succession of scattering interaction event the particle with a remaining energy exits the scintillator, thus the energy absorption efficiency is less than 100%. The scintillator’s energy absorption efficiency, i.e., the ability to absorb the incident ionizing radiation is dependent on the material properties of the scintillator, the form of the incident ionizing radiation, the energy of the incident ionizing radiation, scattering, and other phenomena known to a person of ordinary skill in the art. Consequently, the energy absorbed in the scintillator may not accurately represent the true dose of the incident ionizing radiation.

Nevertheless, it is possible to construct a mathematical model relating energy of ionizing radiation incident on a scintillator to the scintillator’s energy absorption efficiency as well as conversion efficiency over a range of ionizing radiation field by several methods, e.g., simulation, measurement, and other methods known to a person of ordinary skill in the art. Such a mathematical model is one of the key methods of performing what is known in the field as particle spectroscopy. i.e., measurement of energy of ionizing radiation in a “pulse counting with magnitude measurement” mode. Such a mode both counts the number of discrete scintillating events and measures the magnitude of each of the discrete scintillating events. This “pulse-measurement” mode is implemented by mating the scintillator to an optoelectronic sensor capable of capturing the optical photons generated by the discrete scintillating events, e.g., a photomultiplier tube, avalanche photodiode or silicon photomultiplier, to provide an output signal in a form of pulses. A processing electronic communicatively coupled to the optoelectronic sensor is configured to both count the pulses and to measure the magnitude of each of the pulse. The summation of the counts’ magnitudes per unit of time is proportional to the rate of energy deposited into the scintillator.

Consequently, a device utilizing a scintillator operating in the pulse-counting with magnitude mode provides a measure of dose rate. This is in contrast to the operation of a Geiger counter, which cannot utilize this mode due to the magnitude of pulses generated by Townsend effect being independent of energy.

The previous two modes of using a scintillator can be employed for measuring the dose rate provided that the ionizing radiation flux is at a level so that the optoelectronic sensor and the processing electronic are able to distinguish the discrete scintillation events. In addition, the scintillator is also capable of being utilized when the ionizing radiation flux is at a level that the optoelectronic sensor and the processing electronic are unable to distinguish the discrete scintillation events. This manner of operation known as current mode, cannot be achieved by the Geiger–Müller tube, which can only provide a pulsed output, an accuracy of which is severely degraded when the flux of ionizing particles causes these pulses to arrive too frequently. The physical basis for this difference is the fact that the scintillator has a very large number of individual atoms or molecules each of which can detect a scintillation event and recover independently, whereas as disclosed supra, the Townsend discharge event must be fully extinguished prior to the Geiger–Müller tube being able to detect subsequent particles through a subsequent Townsend discharge event.

Although the scintillator cannot distinguish the discrete scintillation events in the current mode, the energy deposited into the scintillator by the incident ionizing radiation could be determined by integrating the magnitude of the signal output from the photodetector if all ionizing particles had the same energy, and an energy absorption efficiency and a conversion efficiency of the scintillator’s material were known for the ionizing particles’ energy. However, due to the fact that the incident ionizing radiation may comprise ionizing particles of different energies and the discrete scintillation events cannot be distinguished, the per particle energy absorption is not known; consequently, accurate dose rate measurement is not currently possible in this mode.

Accordingly, there is a need in the art for an improved design of a system and a method for measuring some forms of ionizing radiation dose rate that provides accurate readings over a wide dynamic range of dose rates in current mode, as well as additional advantages.

### SUMMARY OF THE INVENTION

In an aspect of the disclosure, a design of a system and a method for measuring some forms of ionizing radiation dose rate that provides accurate readings over a wide dynamic range of dose rates and from ionizing radiation particles which have a broad range of energies. Additional aspects are disclosed in the dependent claims.

Specific realizations of this invention can be designed to remain functional and accurate after exposure to the initial nuclear effects in proximity to a nuclear detonation, surviving both the initial prompt neutron and gamma radiation pulse as well as residual gamma dose which accumulates in a contaminated fallout field.

### BRIEF DESCRIPTION OF THE DRAWINGS

The foregoing aspects described herein will become more readily apparent by reference to the following description when taken in conjunction with the accompanying drawings wherein:

FIG. 1 depicts an axonometric view of a conceptual structure of a system providing accurate gamma dose rate measurement in accordance with an aspect of this disclosure.

FIG. 2A depicts a conceptual structure extending the intended range of measured ionizing radiation field while maintaining an acceptable error performance in accordance with an aspect of the disclosure.

FIG. 2B depicts the intended range of the ionizing radiation field measured by the conceptual structure of FIG. 2A.

FIG. 3A depicts a conceptual structure extending the intended range of measured ionizing radiation field while maintaining an acceptable error performance in accordance with yet another aspect of the invention.

FIG. 3B depicts the intended range of the ionizing radiation field measured by the conceptual structure of FIG. 3A.

FIG. 4 depicts a conceptual structure mitigating inherent noise floor limiting low detection limit in accordance with an aspect of this disclosure.

FIG. 5 depicts a conceptual structure mitigating inherent noise floor limiting low detection limit in accordance with another aspect of this disclosure.

FIG. 6 depicts a conceptual structure mitigating inherent noise floor limiting low detection limit in accordance with yet another aspect of this disclosure.

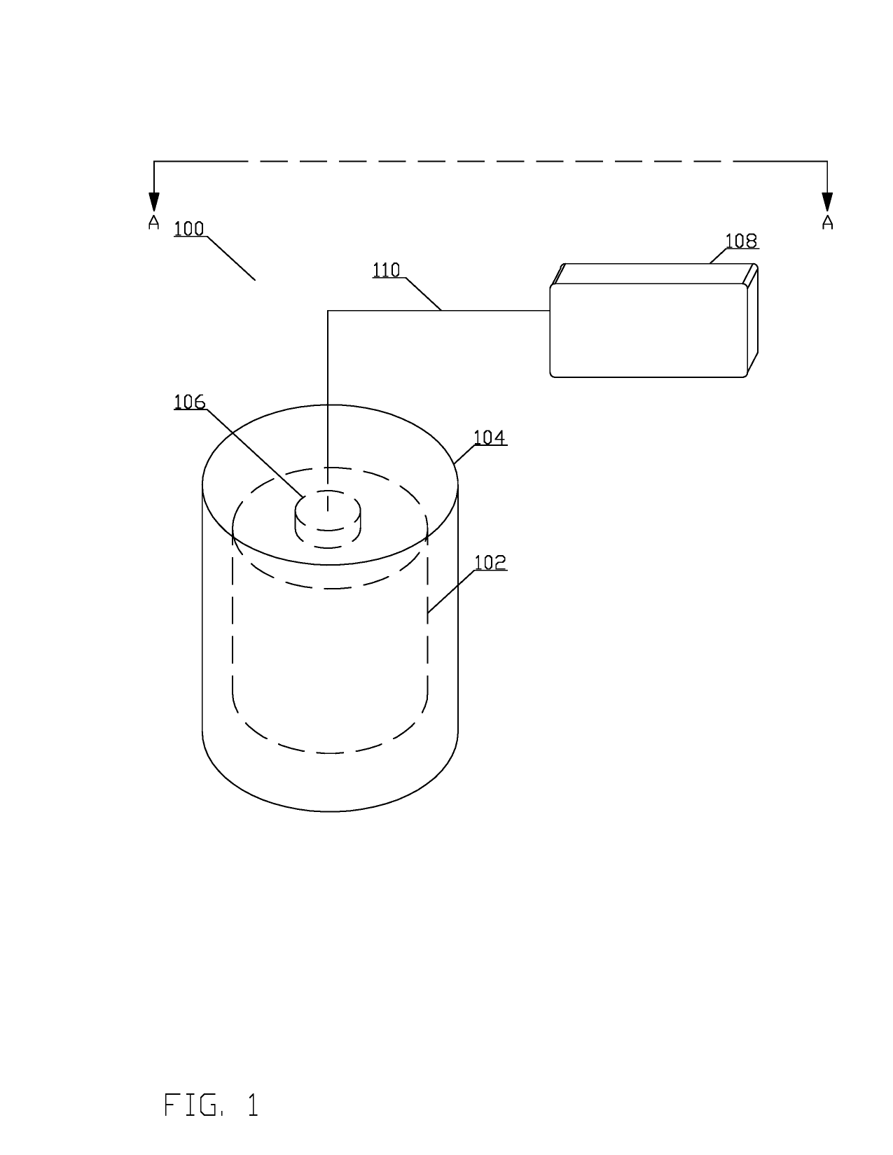

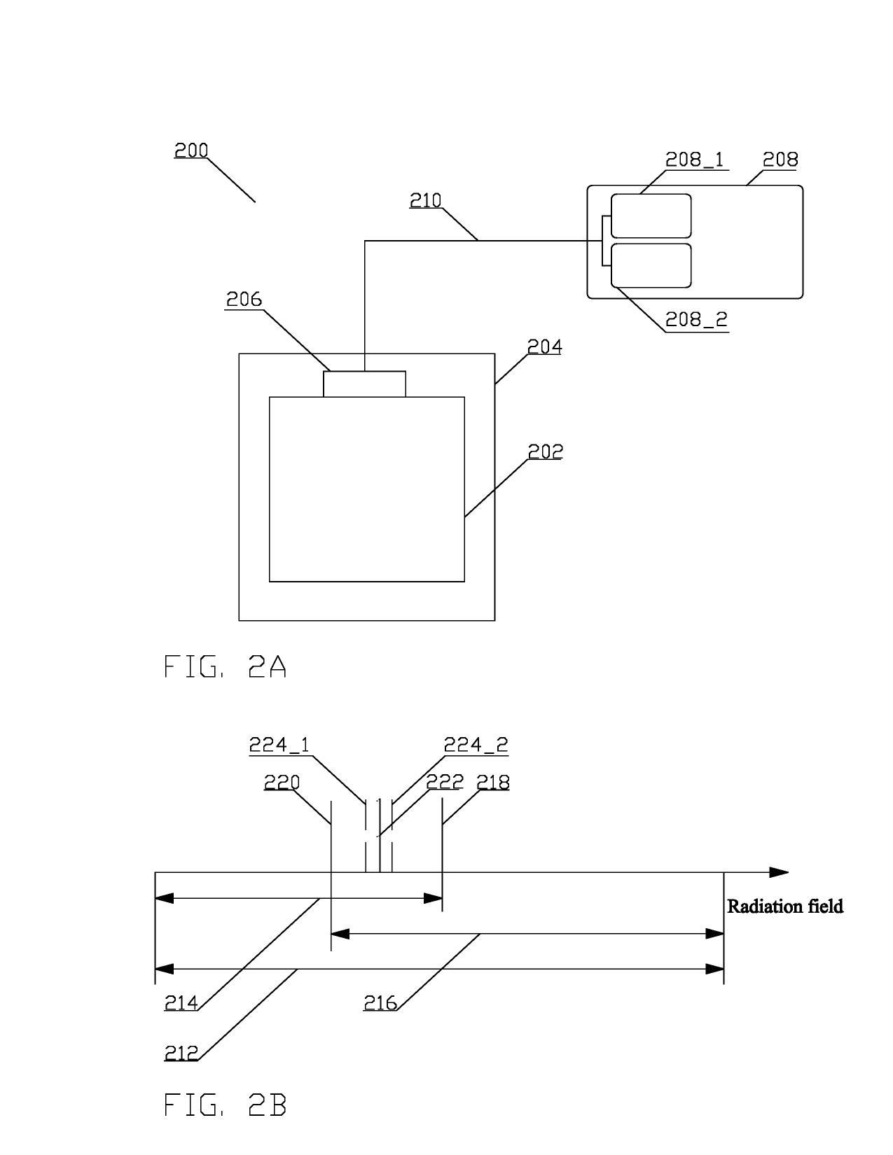

The conceptual structure of FIGS. 2A, 3A, 4, 5, and 6 are depicted along the cut-out A-A in FIG. 1. The description of like structural elements among the figures, is not repeated, the like elements have reference numerals differing by an integer multiple of 100, i.e., reference numeral 100 in FIG. 1 becomes reference numeral 200 in FIGS. 2A, 2B; unless differences and/or alternative aspects are explicitly noted. An expression "_X" in a reference indicates an instance of an element of a drawing where helpful for better understanding.

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms "a," "an," and "the" are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term "and/or" includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects presented throughout this disclosure will be readily apparent to a person having ordinary skill in the art, and the concepts disclosed herein may be extended to other applications.

FIG. 1 depicts a conceptual structure of the system 100 for ionizing radiation dose rate measurement in accordance with an aspect of this disclosure. The elements comprise hardware and/or software entities implementing the blocks and/or the block’s functionality.

The system 100 comprises a scintillator 102, an energy compensation shield 104 disposed around the scintillator 102, at least one photodetector 106 communicatively coupled to the scintillator 102, and a processing electronic 108 communicatively coupled 110 to the at least one photodetector 106. Although the scintillator 102, is depicted as a cylinder, such is for explanation purposes only and any shape is contemplated. The shape may be determined by design considerations, e.g., ease of manufacture/optimum production yield, optimum use of available space, and other considerations known to a person of ordinary skill in the art.

The scintillator 102 comprises material exhibiting scintillation. Such a material may be a solid, crystalline form, liquid, polymer, or other forms known to a person of ordinary skill in the art. The physical properties of the scintillator 102, i.e., volume and scintillating material, determine the scintillator’s energy absorption efficiency. As well known in the art and disclosed supra, for given properties of a scintillator, the energy absorption efficiency can be described as a statistically averaged probability and depends on the energy of particles comprising the incident radiation field. In general, interactions of low energy particles with the scintillator may result in absolute absorption, i.e., the energy absorption efficiency is 100%. Interaction of higher energy particles with the scintillator may result in only partial energy absorption efficiency, i.e., less than 100%. Furthermore, a particle with very high energy may not be absorbed at all, i.e., the particle passes through the scintillating material without any interaction, resulting in energy absorption efficiency of 0%.

The physical properties of the scintillator 102 are selected to result in energy absorption efficiency that optimally absorbs the incident ionizing radiation over the intended range of the ionizing radiation field and for the specific implementation of the radiation dose rate measurement system as determined by design criteria. Such physical properties may comprise e.g., type of scintillation material that determines a scintillator’s conversion efficiency i.e., number of generated optical photons per unit of particle energy, and a volume that together with the type of scintillation material determines the scintillator’s energy absorption efficiency. Such measurement systems may comprise, e.g., systems wherein large scintillator volumes together with appropriate scintillator material may be selected for high-sensitivity fixed installation systems when cost and portability are not constrained. Conversely, a small scintillator volume together with appropriate scintillator material may be selected when size, weight or cost are a priority, e.g., hand carried systems. The term “optimally absorb” is understood as an ability of the scintillator to absorb at least the minimum energy required for accurate measurement in accordance with all aspects of the design criteria, e.g., intended range of the ionizing radiation field – implying an energy absorption efficiency and conversion efficiency, required measurement accuracy, required size, cost, and other criteria known to a person of ordinary skill in the art.

Since as disclosed supra, the energy absorption efficiency depends on the physical properties of the scintillator 102, the energy absorption efficiency must be determined for the specific scintillator 102 by measurement, simulation, or other methods known to a person of ordinary skill in the art for all possible particles’ energies in the intended range of the ionizing radiation field.

An absorption of a particle of the ionizing radiation field incident on the scintillator 102 generates a number of optical photons related to the particle’s energy. This conversion efficiency, i.e., the number of the generated optical photons depends on the scintillating material and can be expressed in number of optical photons per unit of absorbed energy, e.g., 54 optical photons per 1keV. Although in the first approximation the conversion efficiency may be considered to be a linear function of the particle’s energy, for accurate dose rate measurement, the conversion efficiency must be determined for a specific scintillator 102 by measurement, simulation, or other methods known to a person of ordinary skill in the art for all possible particles’ energies in the intended range of the ionizing radiation field.

To enable accurate dose rate measurement, the disproportional absorption among particles of different energies due to energy absorption efficiency of the scintillator 102 must be corrected. However, since discrete scintillation events in the current mode are no longer distinguishable, i.e., many particles may be absorbed simultaneously, the energy correction must account for the total energy deposited into the scintillator 102 by the plurality of indistinguishable scintillation events. Such an energy correction is achieved by employing an energy compensation shield 104, configured to fully enclose the scintillator 102. The shield 104 is designed to selectively absorb the ionizing radiation incident on the energy compensation shield 104 according to the particles’ energies. By means of an example, consider that the ionizing radiation comprises 100 particles with energies of 100 keV and 10 particles with energies of 1000 keV incident of the energy compensation shield 104. To correct the different energy absorption efficiency of the scintillator 104 for different particles’ energies (e.g., 100 % of the particles with energies of 100 keV, and 40 % of the particles with energies of 1000 keV), the energy compensation shield 104 is designed to attenuate, i.e., block, 60 % of the particles with energies of 100 keV and not to block any of the particles with energies of 1000 keV. Therefore, the thusly modified radiation incident on the scintillator 102 comprises 40 particles with energies of 100 keV and 10 particles with energies of 1000 keV. Thus, in both cases the same energy will be absorbed by the scintillator 102, i.e. 1.00 x 40 x 100 keV = 4000 keV and 0.40x 10 x1000 keV = 4000 keV. In each case, for a material with the exemplary scintillation efficiency of 54 photons per keV, 4000 keV of absorbed energy will be converted to 2.16x10⁵ optical photons and an equal optical signal will be measured for an equal incident dose. Thus, as the example illustrates, the energy compensation shield 104 is designed to absorb the particles’ energies in approximately inverse relationship to the scintillator’s 102 particles’ energy absorption efficiency.

Such an energy compensation shield 104 design is accomplished by a selection of the shield’s material and/or combination(s) of materials of varying atomic elements, since materials with different atomic elements have different energy response, i.e., different energies of the ionizing radiation incident on the energy compensation shield 104 are attenuated by different degrees. Such an attenuation is due to various mechanisms for radiation absorption, e.g., the photoelectric effect, Compton scattering, and pair production, all of which depend on the atomic number of the element, and other mechanisms known to a person of ordinary skill in the art. The relative importance of the three named mechanisms depends on the particle energy of the ionizing radiation. In addition to the selective attenuation of the different particles’ energies due to the material(s) selection, the attenuation of the particles’ energies may be further varied by varying the thickness of the shield material, by combining layers of different materials and in different thicknesses including a patchwork of such combined materials.

Once the energy absorption efficiency and the conversion efficiency are established, the measured optical signals generated from either a single ionizing radiation particle, or from multiple radiation particles in aggregate, can be directly related to dose for all particle energies of interest. The total dose rate can be determined by processing the optical signal produced by a photodetector according to the mode in which the photodetector operates, as described in detail infra. Such a determination can be performed even in a heterogenous radiation field of mixed particle flux and particle energy.

The at least one photodetector 106 is communicatively coupled with at least one of the surfaces of the scintillator 102 to ensure that the optical photons generated by the scintillator 102 reach the photodetector 106 with minimal attenuation. Such communication coupling can be achieved by optical coupling between the least one photodetector 106 and the at least one of the surfaces of the scintillator 102, via, e.g., index matching fluid, fiber optics, light guide, and other arrangements known in the art. The photodetector 106 detects and quantifies the stream of optical photons emitted from the scintillator 102, by converting the stream of optical photons into an output signal, e.g., current, voltage, or other quantity known to a person of ordinary skill in the art, that can be processed by the processing electronic 108.

The photodetector 106 may exhibit either a linear or a non-linear relationship between the optical photons and the output signal. The former simplifies the design and functionality of the processing electronic 108, the latter requires that the relationship between the optical photons and the output signal is characterized, by component level characterization from data sheets and/or measurements, or by calibration of the integrated system. The processing electronic 108 is then configured to correct the non-linearity utilizing characterization of the non-linearity in the form of a look-up table, a function, or other means known to a person of ordinary skill in the art.

In one aspect of the invention, the system 100 is used in current mode. That is, the system 100 is designed so that the measured signal is an integration of the photodetector output. Current mode may be used over the intended range of ionizing radiation field where the scintillation events generate continuous flow of optical photons. Since the photodetector 106 does not need to detect individual events, the photodetector 106 technology is selected optimizing a signal-to-noise ratio (SNR) and a dynamic range rather than a response time, and technologies, e.g., photodiode, silicon photomultiplier (SiPM), addressable pixelated optical image sensors, e.g., charge-coupled device (CCD) optical image sensor and complementary metal oxide semiconductor (CMOS) optical image sensor, which are integrated circuits containing an array of linked and individually addressable pixels in a form of capacitors for the CCD and in a form of field-effect transistor amplifiers for the CMOS, and other such technologies known to a person of ordinary skill in the art can be used. An advantage of using such technologies is a wide detection range of ionizing radiation field, on the lower limit due to the SNR performance, and/or on the higher limit due to the dynamic range. For example, a typical SiPM detector has a dynamic range with linear output with respect to optical input over 3 decades. With additional non-linearity corrections this dynamic range can be extended to perhaps 4 decades. A photodiode can have linear output over nine decades of optical input. Furthermore, due to a well-known tradeoff between a response time, the SNR, and dynamic range, generally reflected in a price, such technologies are relatively inexpensive. However, the use of a fast photodetector 106 is not precluded by the current mode, cf. the exemplary use of the SiPM detector, that in addition to a SNR suitable for use in current mode has a short response time, making it suitable for a pulse-counting with magnitude mode.

The output signal from the least one photodetector 106 is provided to the processing electronic 108. The processing electronic 108 corrects the received signal for temperature and amplitude dependent non-linearities in the scintillator, and in case of non-linear photodetector 106 output signal, for such a non-linearity. Such corrections can be carried out by the processing electronic 108 utilizing output signal from temperature sensor(s) (not shown), in a proximity of the scintillator 102. The non-linearities can be characterized in the form of a look-up table, a function, or other means known to a person of ordinary skill in the art.

The corrected photodetector 106 output signal is then integrated over a pre-determined time interval and converted to dose rate by means of a scaling factor, which can take a form of a look-up table, a function, or other forms known to a person of ordinary skill in the art. The output signal can be integrated by analog integration, by digital integration or other integration known to a person of ordinary skill in the art. The integrated signal is then displayed and/or provided to an optional data acquisition system (not shown) communicatively connected to the processing electronic 108 .

In another aspect of the invention, the system 100 is used in a pulse-counting with magnitude mode. The term magnitude as related to the pulse-counting with magnitude mode is understood as any characterization of the pulse, e.g., a peak value of the pulse, an area under the pulse envelope, and other characterization known to a person of ordinary skill in the art. That is, the system 100 is designed so that over the intended range of ionizing radiation field the scintillation events generate discrete pulses of optical photons. However, instead of using the mathematical model relating the energy of the particles of the ionizing radiation field to the energy absorption efficiency and conversion efficiency a compensation shield 104 may be utilized. Since the underlying physical principles of the energy absorption efficiency and conversion efficiency of the scintillating material are agnostic to the mode used, the design of the scintillator 102 and the energy compensation shield 104 is designed according to the principles described supra.

Since the individual pulses of optical photons generated by the discrete scintillation events must be captured by the photodetector 106, a response time of the photodetector 106 is a critical property. The response time must be short enough to enable distinguishing the pulses of optical photons at the upper limit of the flux in the intended range of ionizing radiation field. Nevertheless, the photodetector’s 106 SNR must be high enough to enable to distinguish the pulses of optical photons from the noise at the lower limit of the intended range of ionizing radiation. Additionally, the photodetector’s 106 dynamic range must produce an unsaturated output signal over the intended range of the ionizing radiation field. Based on the preceding requirements, the photodetector 106 comprises any of the photodetector technologies, e .g., a photomultiplier tube, an avalanche photodiode, a Silicon PhotoMultiplier (SiPM), and other photodetector technologies satisfying the above-mentioned criteria, known to a person of ordinary skill in the art. Due to a well-known tradeoff to persons of ordinary skill in the art between a response time, the SNR, and dynamic range, these photodetector technologies are generally more expensive than the photodetector technologies used in the current mode.

The output signal from the at least one photodetector 106 is provided to the communicatively coupled processing electronic 108 . The processing electronic 108 must be designed to have sufficient time resolution to capture the discrete pulses corresponding to the detected scintillation events as well as measure the magnitude of the discrete pulses. The processing electronic 108 corrects the received signal for temperature and amplitude dependent non-linearities in the scintillator 102, utilizing output signal from temperature sensor(s) (not shown), in a proximity of the scintillator 102, and characterizing a relation between the output signal of the scintillator 102 over a temperature range based on the design criteria. The non-linearities can be characterized in the form of a look-up table, a function, or other means known to a person of ordinary skill in the art. Similarly, should the photodetector 106 produce a non-linear output signal, the processing electronic 108 corrects photodetector’s 106 non-linearity by characterizing a relation between the output signal of the scintillator 102 over an input signal based on the design criteria. The non-linearities can be characterized in the form of a look-up table, a function, or other means known to a person of ordinary skill in the art.

Since the measurement is inherently contaminated by noise from the scintillator 102, the photodetector 106, and the processing electronic 108, the processing electronic 108 further provides an adjustable threshold to reject noise by only considering output signal, a magnitude of which is above the threshold, thus improving SNR and sensitivity of the system 100.

In one aspect of the invention, the threshold may be determined by measuring the output signal of the photodetector 106 as a function of the one or more environmental variables considered to affect the photodetector’s 103 performance, e.g., temperature, radiation damage, and other environmental variables known to a person of ordinary skill in the art. These measurements can be stored in the form of a function or lookup table, and multivariate corrections can be applied by a variety of means, e.g., linear combinations, weighted contributions or through machine learning models. As an example of compiling a look up table of thresholds for a single variable, e.g., a temperature. An entry for each temperature can be determined by measuring an average output signal at each temperature, and adding an additional correction factor based on further statistical properties of the measured signal at that temperature, e.g., standard deviation, variance, skewness, kurtosis, and other statistical properties known to a person of ordinary skill in the art, in order to reduce the frequency of false triggers. This table can then be used to select the appropriate threshold for use in actual operation based on the currently measured temperature.

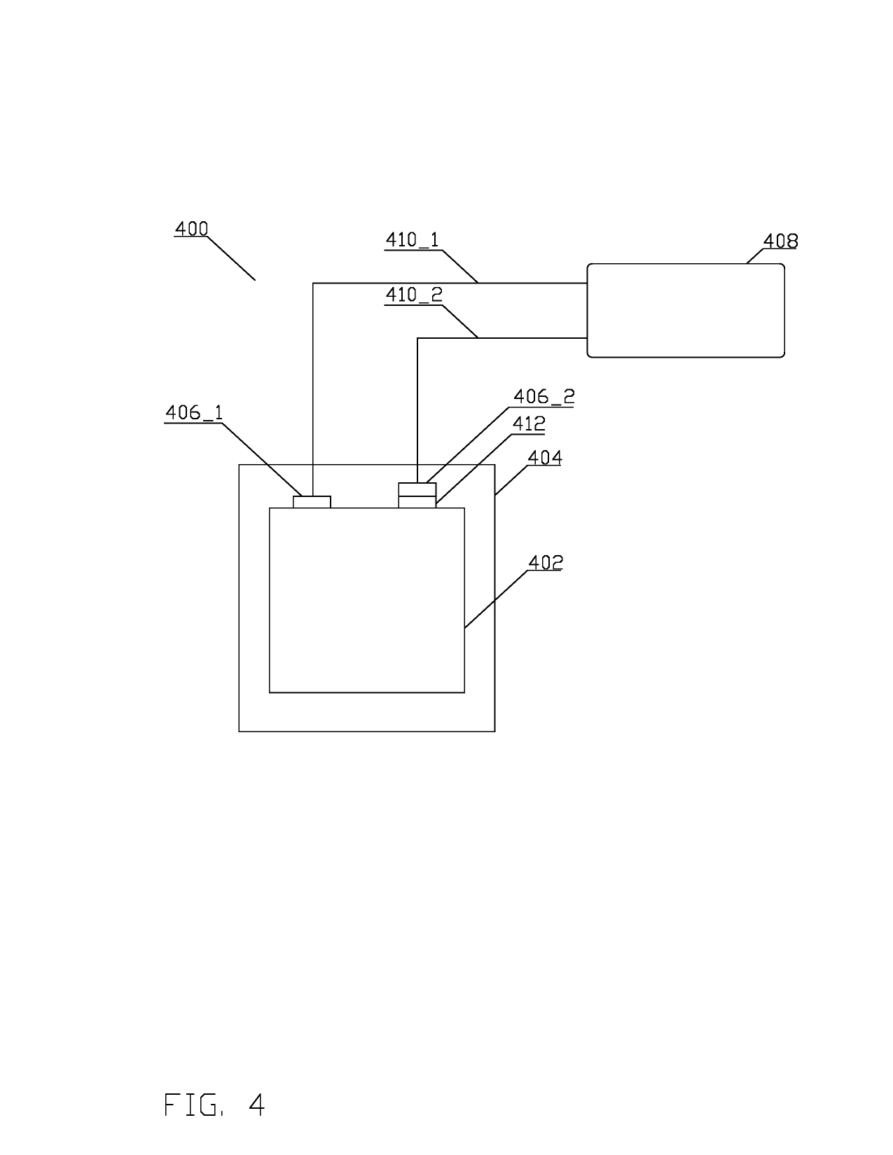

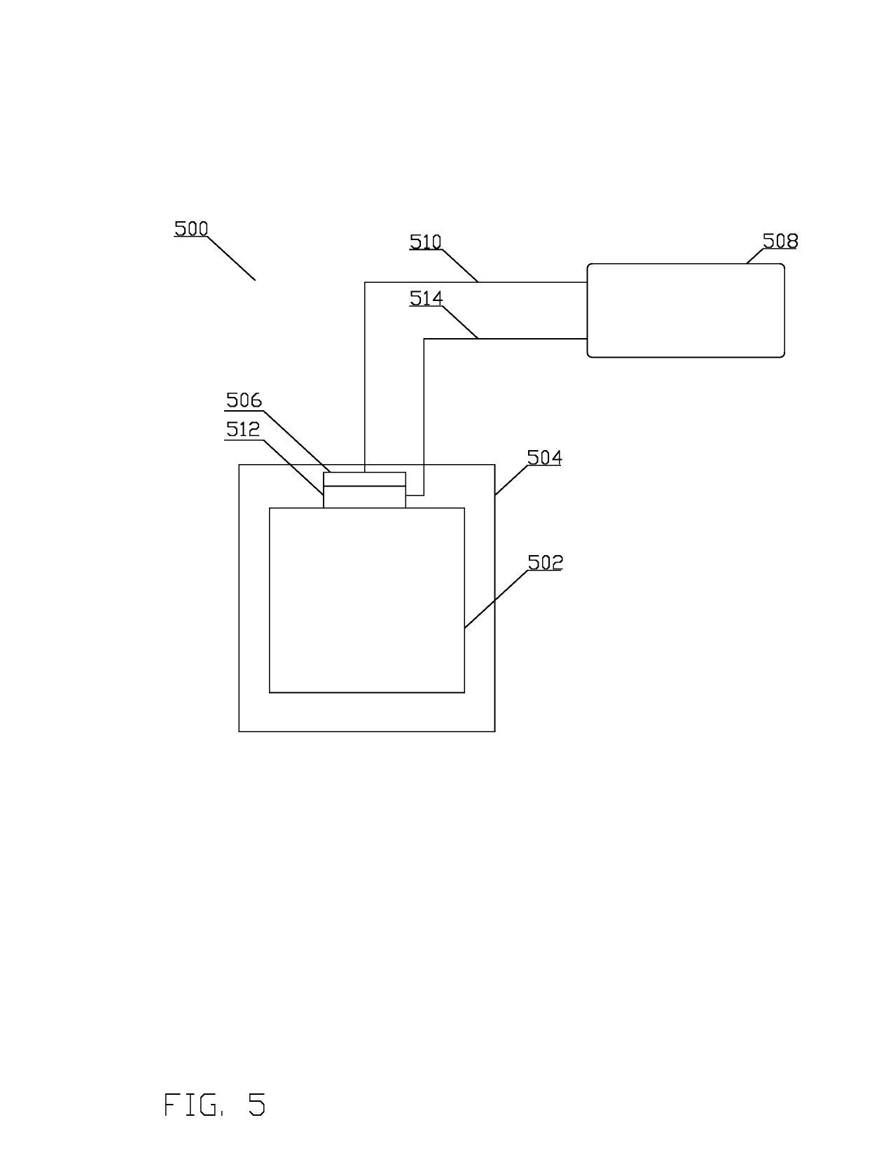

In another aspect of the invention, the adjustable threshold may also be determined by the operator initiating a measurement of the photodetector’s 106 output signal in a low-radiation background before undertaking measurement of the of the radiation field of interest. The measured output signal corresponds to background level of radiation. Such a procedure is routinely used before entering areas of potential radiation exposure in medical, industrial, and nuclear power settings. Should such a low-radiation environment be unavailable, e.g., soldiers on a battlefield, the system 100 is equipped with other means of detecting signals representative of an instrumental noise level, such as a separate reference photodetector which is optically decoupled from the scintillator, cf. FIG. 4 and associated text infra, or the photodetector which has been temporarily decoupled by means of an optical switch, cf., FIG. 5 and associated text infra. The threshold can be determined by using an average of such measured output signal, and adding an additional factor based on further statistical properties of the measured signal, e.g., standard deviation, variance, skewness, kurtosis, and other statistical properties known to a person of ordinary skill in the art, in order to reduce the frequency of false triggers.

In yet another aspect of the invention the means of determining the adjustable threshold are combined. Such combination may first determine the adjustable threshold by consulting the function or the look-up table and then making fine adjustments in accordance with the output signal from the reference photodetector. Additionally, such combination provides a redundancy in case that the reference sensor is damaged, e.g., due to high radiation, and other environmental conditions known to a person of ordinary skill in the art

Further improvement can be achieved by gating the measurement to include not only intervals where the signal exceeds the threshold, thus rejecting the contribution of the noise, but also by optionally extending the measurement interval to include an interval prior to the signal transition exceeding the threshold and/or an interval after signal transition falling below the threshold to ensure the leading and trailing edges of the pulse are included in the measurement. The extension intervals for including the leading and trailing edges can be defined by the characteristic response times of the system e.g., scintillator decay lifetime, detector response time, and other parameters known to a person of ordinary skill in the art; therefore. the extension interval may but do not need to be of the same duration. The acquisition of the signal values preceding the threshold transition depends on the domain of operation of the processing electronic 108. For a processing electronic 108 operating in a digital domain, the acquired signal can be stored before being operated on by the processing electronic 108, alternatively different digital delay can be interposed before the processing electronic 108. For a processing electronic 108 operating in an analog domain, the signal can be stored by means of an analog delay before the processing electronic 108. Such a delay may comprise a bucket brigade circuit, coaxial delay line, and other delays known to a person of ordinary skill in the art.

By summing the magnitudes of the discrete pulses over a specified time, the energy deposited into the scintillator 102 and, consequently, the measured signal over the time may be converted to a dose rate by means of a scaling factor, which can take a form of a look-up table, a function, or other means known to a person of ordinary skill in the art as described supra.

FIG. 2A depicts a conceptual structure of a system 200 intended to work over a design range 212 (FIG. 2B) of the ionizing radiation field. Referring to FIG. 1 for description of the like structures designated by reference numbers, increased by 100 for FIG. 2A, by proper design of the scintillator 202 , the energy compensation shield 204, and photodetector 206, the photodetector 206 can operate in the pulse-counting with magnitude over a first sub-range 214 up to a limit 218, which is determined by the maximum level of ionization radiation field wherein the photodetector 206 is capable of distinguishing individual pulses.

The selection criteria for the photodetector’s 206 characteristics for operation over the first sub-range 214 are the same as disclosed in description of the pulse-counting with magnitude supra, and accordingly, operation of such photodetector 206 in the first sub-range 214 yields similar SNR performance associated with the pulse-counting with magnitude mode. However, due to a tradeoff between a response time, the SNR, and dynamic range, likewise discussed supra, the photodetector 206 selection must also satisfy the ability to operate over a sub-range 216 in a current mode so that the sub-ranges 214 and 216 overlap to enable selecting between modes. This requires a selection of a photodetector 206, a lower limit 220 of which is determined by the minimum signal to noise satisfying the design criteria, and the dynamic range generally presents a limit on operation of the photodetector 206 in the current mode in the range 212. Specifically, the limited dynamic range causes saturation of the photodetector 206.

Selecting between photodetector’s 206 modes may be accomplished by the processing electronic 208. comprising a pulse-counting with magnitude detector 208_1, processing the photodetector’s 206 output signal in the pulse-counting with magnitude mode, and a current detector 208_2 processing the photodetector’s 206 output signal in the current mode. Selecting between the modes can be accomplished by several selecting function designs.

In one aspect, the selecting function comprises a fixed threshold 222 with hysteresis spanning the band between 224_1 and 224_2. The threshold 222 is determined in accordance with considering the characteristics of the photodetector’s 206 output signal detected by the pulse-counting with magnitude detector 208_1 and the current detector 208_2, e.g., SNR, errors caused by correcting large degrees of non-linearity, temperature effects, and other characteristics known to a person of ordinary skill in the art, and the design criteria for the measurement system. Such criteria may, e.g., emphasize linearity over SNR, SNR over dynamic range, and the like. The threshold 222 may be determined by measuring the output signal of the photodetector 206 as a function of the one or more environmental variables considered to affect the photodetector’s 206 performance, and represented as a function or a look-up table as described supra. Since as described supra, the ionizing radiation is a stochastic process, the hysteresis is needed to prevent frequent selecting between the modes. The hysteresis band between 224_1 and 224_2 is determined in accordance with the does rate specified by the design parameters and required system response time. The relationship between the dose rate level to be measured and the required response may be prescribed by customer requirements or by standards bodies, for example IEEE/ANSI standard N42.17AC (2022), Table 6.

In another aspect, the selecting function comprises a dynamically adjusted threshold 222 with hysteresis spanning the band between 224_1 and 224_2. As the environmental condition, e.g., temperature, radiation dose, potential damage due to high radiation, and other environmental conditions known to a person of ordinary skill in the art, change, so do change the photodetector’s 206 characteristics, e.g., signal to noise ratio, dynamic range, and other characteristic known to a person of ordinary skill in the art. The threshold is adjusted in response to the changing conditions, so that the measurement is within the design parameters of the measurement system. By means of an example, consider that the current detector 208_2 reports high signal to noise ratio at high dose rate levels. As the dose rate level decreases so does the current detector 208_2 signal to noise ratio. Eventually the noise level is greater than that of the pulse-counting with magnitude detector 208_1. Similar examples can comprise a dynamic range as a function of dose rate level, an uncorrectable non-linearity as a function of dose rate level, and other dependencies known to a person of ordinary skill in the art. The threshold 222 may be represented as a function or a look-up table as described supra. The hysteresis band between 224_1 and 224_2 is determined in accordance with the does rate specified by the design parameters and required system response time. The relationship between the dose rate level to be measured and the required response may be prescribed by customer requirements or by standards bodies, for example IEEE/ANSI standard N42.17AC (2022), Table 6.

In yet another aspect, the selecting function comprises a combination function utilizing contribution of both the pulse-counting with magnitude detector 208_1 and the current detector 208_2 so that the resulting error of the detector’s combined output signal is within the design criteria of the measurement system. The relative proportion of each detector’s output signal contribution is dynamically determined by each detector’s characteristics such as response time, dynamic range, non-linearity, SNR, and other characteristics known to a person of ordinary skill in the art. The relative proportion of each detector’s signal may be determined by various means including a fixed combination, a linear combination function derived from relative error contributions from each detector at the extremes of the overlapping range, or by continuous optimization using instantaneous error estimates derived for each detector. By means of an example, consider the pulse-counting with magnitude detector 208_1 that reports high SNR but with a high degree of non-linearity as a function of change in environmental conditions, e.g., increasing dose rate level and/or temperature, while a current detector 208_2 has lower SNR but a low degree of non-linearity with respect to such change in environmental conditions. By selecting an appropriate threshold, whether fixed or dynamic, for the selecting function the resulting detector’s combined output signal may keep the error within the design criteria of the measurement system.

Selecting a photodetector 206 with properties satisfying the requirements on response time, SNR, and dynamic range satisfying the design criteria generally requires use of an expensive photodetector 206, and, depending on the design criteria, e.g., expense, size, intended range 212 of the ionizing radiation field, and other design criteria known to a person of ordinary skill in the art, no such a photodetector 206 may exist.

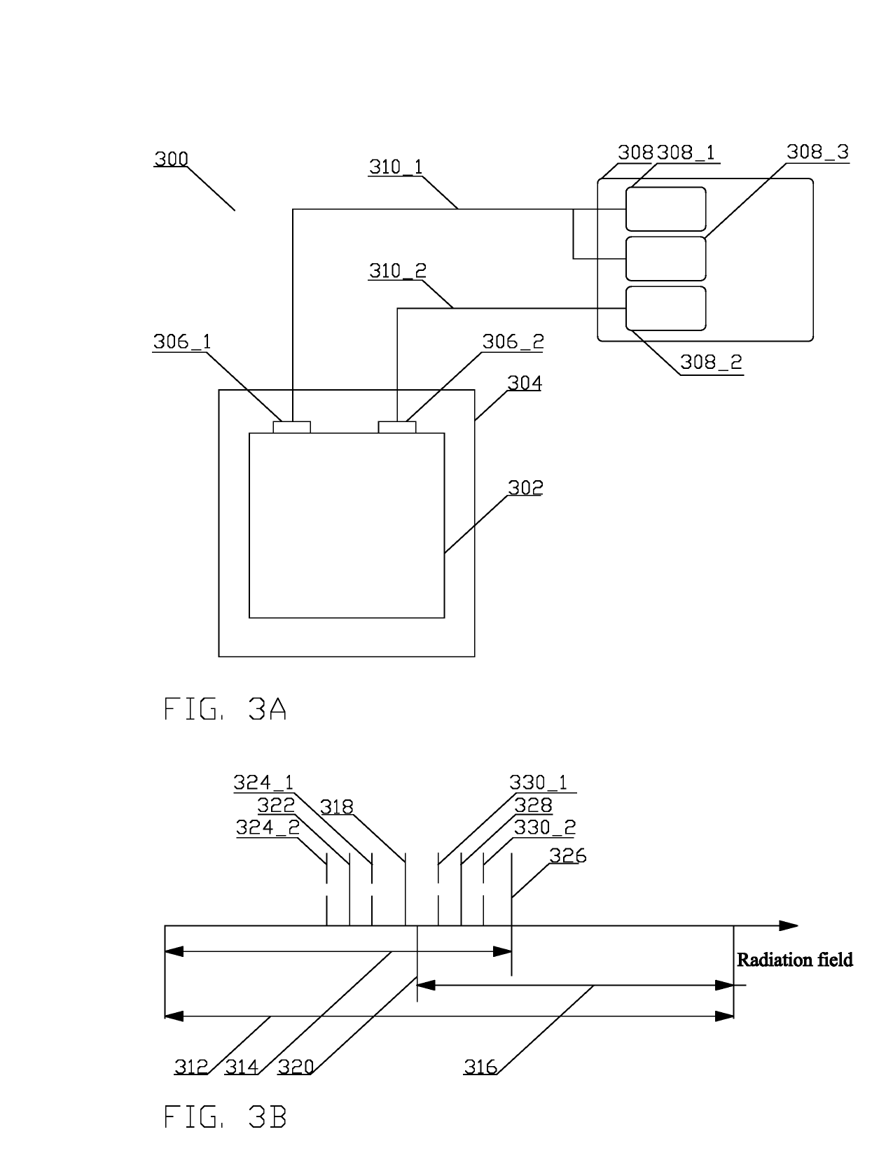

Referring to FIG. 3A, depicts a conceptual structure of a system 300 intended to work over an intended range 312 (FIG. 3B) of the ionizing radiation field. The potential limitation of the single detector 206 (FIG. 2A), may be ameliorated by utilizing two photodetectors. Referring to FIG. 1 for description of the like structures designated by reference numbers, increased by 200 for FIG. 3A, a first photodetector 306_1, selected with properties optimized to operate over a first sub-range 314, wherein, the first photodetector 306_1 operates in a pulse-counting with magnitude mode up to a limit 318, which is determined by the maximum level of ionization radiation field wherein the first photodetector 306_1 is capable of distinguishing individual pulses, and continues to operate in a current mode over the rest of the range 314, up to a limit 326 wherein the non-linearity of the first photodetector 306_1 can no longer be corrected with precision required by the design criteria. These requirements, i.e., tradeoff between a response time, the SNR, and the uncorrectable non-linearity, determine the photodetector’s 306_1 selection.

Since the photodetector 306_1 operates in both the pulse-counting with magnitude mode and the current mode, the conceptual structure of a system 300 must support selecting between the modes. Accordingly, the processing electronic 308 comprises an additional current mode detector 308_3, and the output signal from the photodetector 306_1 is routed to both the pulse-counting with magnitude detector 308_1 and the current detector 308_3. Consequently, the selecting functions between the two modes is accomplished by the same means as described in FIG. 2 and associated text, i.e., a fixed threshold 322 with hysteresis spanning the band between 324_1 and 324_2, a dynamically adjusted threshold 322 with hysteresis spanning the band between 324_1 and 324_2, and a contribution of both the pulse-counting with magnitude detector 308_1 and the current detector 308_3 so that the error of the resulting detectors’ combined output signal is within the design criteria of the measurement system.

A second photodetector 306_2, selected with properties optimized to operate in a current mode over a second sub-range 316, the lower limit 320 of which is determined by the minimum signal to noise satisfying the design criteria, and the dynamic range generally presents a limit on operation of the photodetector 306_2 in the current mode in the range 316 Specifically, the limited dynamic range causes saturation of the photodetector 306_2. Accordingly, the output signal of the photodetector 306_2 is routed to a current detector 308_2.

As an additional requirement, the sub-ranges 314 and 316 must overlap to enable selecting between the photodetectors 306_1 and 306_2. This requires that the photodetectors 306_1 upper limit 326 exceeds the photodetector’s 306_2 lower limit 320.

Selecting between the photodetector 306_1 and the photodetector 306_2 may be accomplished by the processing electronic 308 utilizing several means. In one aspect, the selecting function is a fixed threshold 328 with hysteresis spanning the band between 330_1 and 330_2. The threshold 328 is determined in accordance with the characteristics of the photodetectors 306_1, 306_2 in the overlapping region, e.g., SNR, errors caused by correcting large degrees of non-linearity, temperature effects, and other characteristics known to a person of ordinary skill in the art, and the design criteria for the measurement system. Such criteria may, e.g., emphasize linearity over SNR, SNR over dynamic range, and the like. The threshold 328 may be determined by measuring the output signal of the photodetectors 306_1, 306_2 as a function of the one or more environmental variables considered to affect the photodetectors’ 306_1, 306_2 performance, and represented as functions or look-up tables as described supra. Since as described supra, the ionizing radiation is a stochastic process, a hysteresis is needed to prevent frequent selecting between the photodetectors 306_1, 306_2. The hysteresis spanning the band between 330_1 and 330_2 are determined in accordance with the does rate specified by the design parameters and required system response time. The relationship between the dose rate level to be measured and the required response may be prescribed by customer requirements or by standards bodies, for example IEEE/ANSI standard N42.17AC (2022), Table 6.

In another aspect, the selecting function comprises a dynamically adjusted threshold 328 with hysteresis spanning the band between 330_1 and 330_2. As the environmental condition, e.g., temperature, radiation dose, potential damage due to high radiation, and other environmental conditions known to a person of ordinary skill in the art, change, so do change the photodetectors’ 306_1, 306_2 characteristics, e.g., signal to noise ratio, dynamic range, and other characteristic known to a person of ordinary skill in the art. Since the photodetectors 306_1, 306_2 may be of different technologies or be of the same technology, but be designed with different characteristics, the threshold 328 is adjusted in response to the changing conditions, so that the measurement is within the design parameters of the measurement system. By means of an example, consider a second photodetector 306_2 that has a high signal to noise ratio at high dose rate levels. As the dose rate level decreases so does decrease the second photodetector’s 306_2 signal to noise ratio. Eventually the noise level is greater than that of a first photodetector 306_1. Similar examples can comprise a dynamic range as a function dose rate level, an uncorrectable non-linearity as a function of dose rate level, and other dependencies known to a person of ordinary skill in the art. The threshold 328 may be represented as a function or a look-up table as described supra. The hysteresis bands 330_1 and 330_2 are determined in accordance with the does rate specified by the design parameters and required system response time. The relationship between the dose rate level to be measured and the required response may be prescribed by customer requirements or by standards bodies, for example IEEE/ANSI standard N42.17AC (2022), Table 6.

In yet another aspect, the selecting function comprises a combination function utilizing contribution of both photodetectors 306_1, 306_2 in the resulting combined output signal so that the error is within the design criteria of the measurement system. The relative proportion of each photodetector’s 306_1, 306_2 output signal contribution is dynamically determined by each photodetector’s 306_1, 306_2 characteristics such as response time, dynamic range, non-linearity, SNR, and other characteristics known to a person of ordinary skill in the art. The relative proportion of each detector’s signal may be determined by various means including a fixed combination, a linear combination function derived from relative error contributions from each detector at the extremes of the overlapping range, or by continuous optimization using instantaneous error estimates derived for each detector. By means of an example, consider a first photodetector 306_1 that has high SNR but has a high degree of non-linearity as a function of change in environmental conditions, e.g., increasing dose rate level and/or temperature, while a second photodetector 306_2 has lower SNR but a low degree of non-linearity with respect to such change in environmental conditions. By selecting an appropriate threshold 328, whether fixed or dynamic, for the selecting function the resulting combined output signal may keep the error is within the design criteria of the measurement system.

The above-described conceptual structure of FIG. 3A can be employed in case that it is desired to extend the range 312 as much as possible, while maintaining an acceptable error performance. In a different case, wherein a preference is for the best SNR at the lower portion of the sub-range 314, selection of the photodetector 306_1 can be optimized for this portion of the sub-range 314, and photodetector 306_2 can be selected to operate in pulse-counting with magnitude in at least the rest of the sub-range 314 and to operate in current mode over the rest of the range 312. When amended with combining the output signals of the photodetector 306_1 and the photodetector 306_2 in the pulse-counting with magnitude overlapping region, a low SNR can be achieved. A person of ordinary skill in the art will understand the needed modification of the conceptual structure of FIG. 3A.

A person of ordinary skill in the art will understand that the selection between the pulse-counting with magnitude and current mode of the photodetector 306_1 and selection between the photodetector 306_1 and the photodetector 306_2, may be accomplished by any permutations of the above-described selection function that satisfy the design requirements. That is, selection function for the selection between the pulse-counting with magnitude and current mode of the photodetector 306_1 can be performed by any of the selection functions from the group of the fixed threshold with hysteresis, the adjustable threshold with hysteresis, and the combination. Likewise for the selection between the photodetector 306_1 and the photodetector 306_2.

A person of ordinary skill in the art will further understand that FIGS. 3A and 3B depicting two sub-ranges and using two photodetectors, each photodetector being optimized for the intended sub-range, is for explanation of the concept. Therefore, no limitation on the number of photodetectors is intended and more than two detectors may be used. By means of an example, consider that the photodetectors 306_2 cannot be used over the entire sub-range 316 due to a minimum SNR requirement for measurement at the lower limit 320 and its limited dynamic range preventing reach to the upper limit of the sub-range 316. Consequently, due to the relaxed minimum SNR requirements, an additional photodetector (not shown) may be added to be used over the rest of the sub-range 316, with a partial overlap over the range measured by the photodetector 306_2 to enable selecting. Similarly, more than one detector can be used, each for a portion of the second sub-range 314 each of the plurality of detectors being optimized for the photodetector’s intended portion of the sub-range 314.

A photodetector’s noise floor inherent in a specific technology limits the low detection ability of such a detector. Furthermore, the noise floor is a function of temperature, rising with increasing temperature; therefore, further decreasing the lower limit of detecting.

FIG. 4 depicts a conceptual structure mitigating inherent noise floor limiting low detection limit in accordance with another aspect of this disclosure. Referring to FIG. 1 for description of the like structures designated by reference numbers, increased by 300 for FIG. 4, in addition to a photodetector 406_1, a photodetector 406_2 serving to provide a reference noise floor signal, is optically isolated from the scintillator 402, by means of an optically opaque coating or by embedding an optically opaque material 412 between the reference photodetector 406_2 and the scintillator 402. To ensure similar noise performance over the range of design temperatures, the reference photodetector 406_2 is selected so that the reference photodetector’s 406_2 parameters best match the photodetector’s 406_1 parameters, i.e., the photodetector 406_1 and the reference photodetector 406_2 can be selected so that their noise floor exhibits the smallest difference over the range of design temperature, determined as e.g., the smallest average difference, integrated difference, root mean square error or other statistical dissimilarity estimation techniques. Such selection implies, but does not require, that the photodetector 406_1 and the reference photodetector 406_2 are of the same technology. The photodetectors 406_1 and the reference photodetector 406_2 are positioned relative to each other so that the temperature of the environment affects both in a like manner.

The processing electronic 408 is communicatively coupled with 410_1 and 410_2 and receives output signals from photodetectors 406_1 and 406_2 and subtracts the signal from the photodetector 406_2 from the signal from the photodetector 406_1 thus mitigating the noise floor contribution to the photodetector’s 406_1 signal. In both the current mode and the pulse-counting with magnitude, such a subtraction can be performed continuously.

Additionally, should a shift in the noise floor occur, e.g., due to a partial damage or a change in environmental conditions, e.g., temperature, radiation dose, potential damage due to high radiation, and other environmental conditions known to a person of ordinary skill in the art, affecting the performance of both the photodetectors 406_1 and the reference photodetector 406_2 , the system 400 will still function. The likelihood of the same or correlated damage to both photodetector 406_1 and the reference photodetector 406_2 due to the radiation is high due to the penetrating nature of the radiation. Similarly, due to the relative location of the photodetector 406_ 1 and the reference photodetector 406_2, the temperature effects are likely be the same.

In addition, the configuration can be used to establish a reference signal representative of an instrumental noise level, by measuring the output signal from the reference photodetector 406_2, as described supra.

FIG. 5 depicts a conceptual structure mitigating inherent noise floor limiting low detection limit in accordance with another aspect of this disclosure. Referring to FIG. 1 for description of the like structures designated by reference numbers increased by 400 for FIG. 5, an optical switch 512 is disposed between the scintillator 502 and the photodetector 506. The processing electronic 508 causes the optical switch 512 to periodically optically couple and uncouple the scintillator 502 and the photodetector 506 by means of a control signal 514. During the duration of optical coupling characterized by a first time interval, the processing electronic 508 measures the photodetector’ 506 output signal representing the dose rate. During the duration of optical uncoupling characterized by a second time interval, the processing electronic 508 measures the reference noise signal representing the noise floor. The switching ratio of the periodic control signal 514 coupled duration to the uncoupled duration is determined in accordance with characteristics of the detector to provide reliable measurement of the noise floor.

The processing electronic 508 then subtract the measured noise floor from the output signal from the photodetector 506 measured during the duration, thus mitigating the noise floor contribution to the photodetector’s 506 signal.

Additionally, should a partial damage affecting the performance of the photodetector 506 occur, e.g., due radiation or temperature, contributions to the measured signal from inherent detector noise can still be subtracted from the measurement, thereby maximizing the signal to noise ratio of the system 500.

In addition, the configuration can be used to establish a reference signal representative of an instrumental noise level, by temporarily decoupling the photodetector 506 form the scintillator 502 means of an optical switch, as described supra.

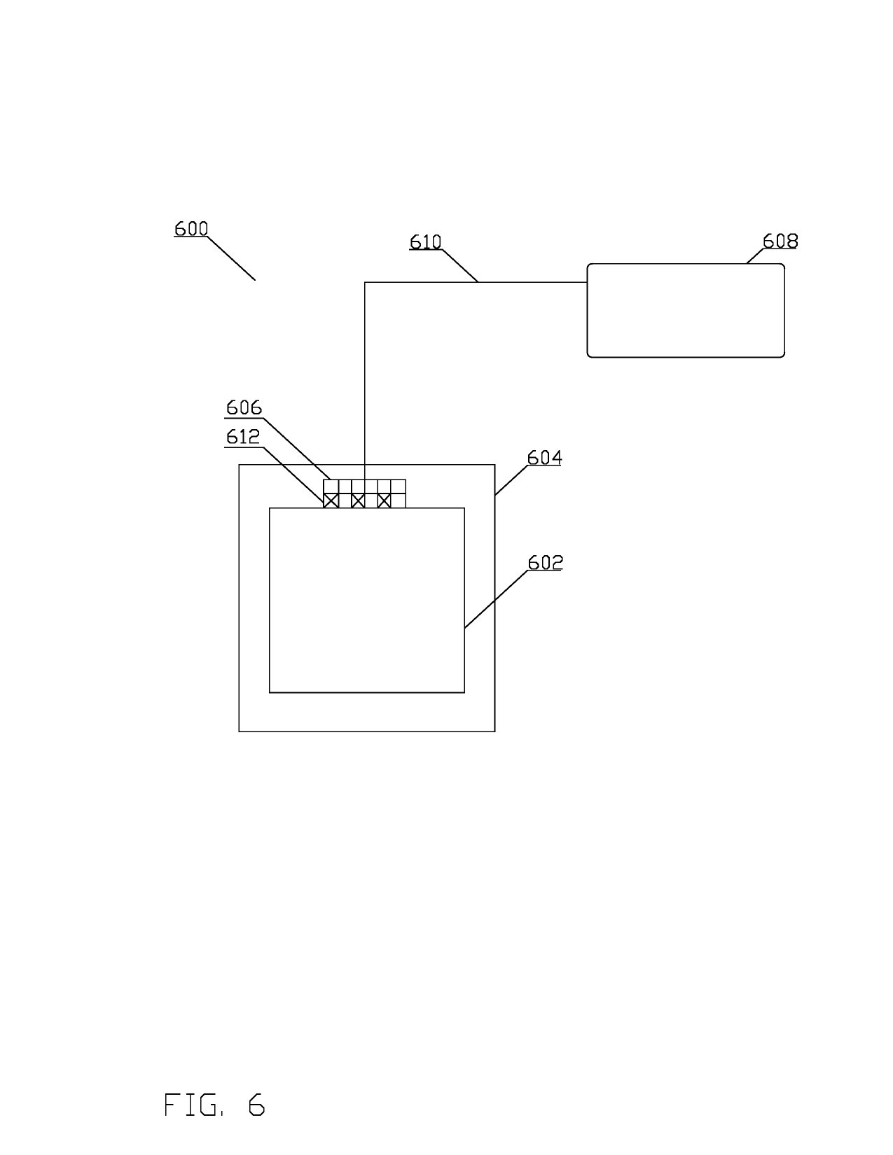

FIG. 6 depicts a conceptual structure mitigating inherent noise floor limiting low detection limit in accordance with another aspect of this disclosure. Referring to FIG. 1 for description of the like structures designated by reference numbers increased by 500 for FIG. 6, the photodetector 606 comprises any addressable pixelated optical image sensor, e.g., CCD optical image sensor, CMOS optical image sensor, and other such sensors known to a person of ordinary skill in the art.

Since each of the pixels of an array comprising the addressable pixelated optical image sensor independently measured output signal contributes to the overall output signal of the photodetector 606, a first plurality of the pixels can be optically isolated from the scintillator 602 by means of masking selected pixels by optically opaque coating or by embedding an optically opaque material 612 masking selected pixels, marked as X, between the photodetector 606 and the scintillator 602, while the second plurality of the pixels can be optically coupled to the scintillator 602. A further advantage of the photodetector 606 is the close thermal coupling of the pixels.

The processing electronic 608 can measure the output signal of both the optically isolated pixels X, and the optically coupled pixels in both the pulse-counting with magnitude and the current mode continuously. The measured output signal of the optically isolated pixels X thus represents the noise floor, and can be subtracted by the processing electronic 608 from the measured output signal of the optically coupled pixels, thus mitigating the noise floor contribution to the photodetector’s 606 signal.

Additionally, radiation damage or a change in environmental conditions, e.g., conditions known to a person of ordinary skill in the art may affect the performance of the photodetector 606. To detect such a potential performance change, the processing electronic 608 actively monitors and assesses the potential performance change by monitoring each pixels’ performance by means of analyzing, e.g., minimum pixel signal, maximum pixel signal, offset from the mean value calculated from all active pixels, and other parameters characterizing pixel’s performance. This analysis identifies pixels, a performance of which has degraded, i.e., pixels with a constant low reported dark signal; pixels with a high dark signal value, i.e. damaged pixels reporting a constant saturated signal; or pixels with altered responsivity, i.e. pixels reporting signals significantly departing from the mean pixel value. In accordance with the analysis, output signal from the pixels failing to satisfying pre-determined criteria, e.g., a signal to noise ratio or anomalous pixel responsivity, are excluded from being processed by the processing electronic 608. By excluding from the measurement the output signal from the pixels failing to satisfy the pre-determined criteria the overall signal to noise ratio of the system 600 is improved over the signal to noise ratio of a partially damaged system 600.

In addition, the configuration can be used to establish a reference signal representative of an instrumental noise level, by measuring the output signal from the from the optically isolated pixels X of the photodetector 606 as described supra.

Specific realizations of this invention can be designed to remain functional and accurate after exposure to the initial nuclear effects in proximity to a nuclear detonation, surviving both the initial prompt neutron and gamma radiation pulse at the time of detonation as well as residual gamma dose which accumulates in a contaminated and fallout field areas following the detonation. Examples of radiation-induced damage include neutron displacement damage, an injury to the inherent crystal lattice of a semiconductor device which can result in a dramatic increase in the background noise in semiconductor-based photodetectors, an effect which is made worse at higher environmental temperatures, or complete disablement of such photodetectors.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein. Thus, the different disclosed aspects may be combined to allow any permutation understood by a person of ordinary skill in the art. By means of an example, the aspect of extending the intended range of measured ionizing radiation field while maintaining an acceptable error performance as depicted in FIGS. 2A, 2B, 3A, and 3B, and described in associated text, may be combined with any of the aspects of the mitigating inherent noise floor limiting low detection limit as depicted in FIGS. 4, 5, and 6 and described in associated text.

Therefore, by means of an example a person having ordinary skill in the art will understand, that the flow chart is not exhaustive because certain steps may be added or be unnecessary and/or may be carried out in parallel based on a particular implementation.

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or flux, optical fields or particles, or any combination thereof.

Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for measuring a dose rate of an ionizing radiation field comprising:
a compensation shield fully enclosing a scintillator and configured to modify the ionization radiation field that passes through the compensation shield to compensate for absorption efficiency and conversion efficiency of the scintillator;
the scintillator configured to convert optimally absorbed energy of the modified ionizing radiation field into optical photons;
at least one photodetector optically coupled to the scintillator configured to convert the optical photons into an output signal; and
a processing electronic communicatively coupled to the at least one photodetector configured to determine the dose rate in accordance with the output signal measurement.

2. The system as claimed in claim 1, wherein the processing electronic is further configured to:
display the determined dose rate, and/or store the determined dose rate, and/or provide the determined dose rate for further processing.

3. The system as claimed in claim 1, wherein the compensation shield modifies the ionization radiation field that passes through the compensation shield to compensate for absorption efficiency and conversion efficiency of the scintillator by being configured to:
selectively absorb the ionizing radiation in approximate inverse relationship to the scintillator’ energy absorption efficiency.

4. The system as claimed in claim 1, wherein the at least one photodetector comprises:
a photodetector configured to convert a continuous stream of the optical photons into an output signal; and
the processing electronic determines the dose rate by being configured to:
correct the output signal measurement for temperature and amplitude dependent non-linearities in the scintillator;
integrate the corrected signal over a pre-determined time interval; and
convert the integrated signal to dose rate by means of a scaling factor.

5. The system as claimed in claim 4, wherein the at least one photodetector is selected from a group of:
a photodiode;
a photomultiplier tube;
a silicon photomultiplier; and
an addressable pixelated optical image sensor.

6. The system as claimed in claim 1, wherein the at least one photodetector comprises:
a first photodetector optically coupled to the scintillator;
a second photodetector optically isolated from the scintillator; and
wherein the processing electronic measures the output signal by being configured to:
receive output signals from both photodetectors and subtract the output signal from the second photodetector from the output signal from the first photodetector.

7. The system as claimed in claim 6, wherein the second photodetector’s parameters best match the first photodetector’s parameters.

8. The system as claimed in claim 1, wherein the at least one photodetector comprises:
an addressable pixelated optical image sensor, a first plurality of pixels of which is optically coupled to the scintillator, and a second plurality of pixels of which is optically isolated from the scintillator; and
the processing electronic measures the output signal by being configured to:
receive output signals from both the first plurality of the optically coupled pixels and the second plurality of the optically isolated pixels; and
subtract the output signal from the second plurality of the optically isolated pixel from the output signal from the first plurality of the optically coupled pixels.

9. The system as claimed in claim 8, wherein the processing electronic is further configured to:
monitor each pixel for a change of the pixel’s performance; and
exclude from measurement the output signal of the pixels the output signal of which fails to satisfy pre-determined criteria.

10. The system as claimed in claim 1, the at least one photodetector comprises:
a photodetector optically coupled to the scintillator via an optical switch disposed between the photodetector and the scintillator; and
the processing electronic measures the output signal by being configured to:
cause the optical switch to optically uncouple the photodetector from the scintillator for a first time interval; and
subtract the photodetector’s output signal measured during the first time interval from the photodetector’s output signal measured during a coupled second time interval.

11. The system as claimed in claim 1, wherein the at least one photodetector comprises:
a single photodetector configured to operate over a range of the ionizing radiation field; and
the processing electronic measures the output signal by being configured to:
measure an output signal of the photodetector in a pulse-counting with magnitude mode over a first sub-range;
measure the output signal of the photodetector in a current mode over a second sub-range; wherein the two sub-ranges partially overlap; and
select between the measured output signals of the photodetector in the partial overlap.

12. The system as claimed in claim 11, wherein the processing electronic selects between the measured output signals in the partial overlap by being configured to:
determine a threshold in accordance with characteristics of the photodetector in the partial overlap;
determine a hysteresis in accordance with the dose rate specified by the design parameters and required system response time; and
select between the measured output signals of the photodetector in the partial overlap in accordance with the threshold and the hysteresis.

13. The system as claimed in claim 11, wherein the processing electronic selects between the measured output signals by being configured to:
determine a threshold in accordance with characteristics of the photodetector in the partial overlap;
determine a hysteresis in accordance with the dose rate specified by the design parameters and required system response time;
dynamically adjust the threshold in accordance with the characteristics to keep a dose rate specified by the design parameters within the design parameters of the system; and
select between the measured output signals of the photodetector in the partial overlap in accordance with the threshold and the hysteresis.

14. The system as claimed in claim 11, wherein the processing electronic measures the output signal by being configured to:
determine relative contribution of each measured output signal of the photodetector in the partial overlap to a resulting output signal so that the error is within the design criteria of the system; and
combine the measured output signals of the photodetector in the partial overlap in accordance with the relative contribution.

15. The system as claimed in claim 1, wherein the at least one photodetector comprises:
a first photodetector configured to operate over a first sub-range of the ionizing radiation field;
a second photodetector configured to operate over a second sub-range of the ionizing radiation field wherein the two subranges partially overlap; and
the processing electronic measures the output signal by being configured to:
measure an output signal of the first photodetector in a first mode over a first section of the first sub-range;
measure the output signal of the first photodetector in a second mode over a second section of the first sub-range;
measure an output signal of the second photodetector over the second sub-range; and
select among the measured output signals.

16. The system as claimed in claim 15, wherein the processing electronic selects among the measured output signals by being configured to:
select between the measured output signal of the first photodetector in the first mode over the first section of the first sub-range and the measured output signal of the first photodetector in the second mode over the second section of the first sub-range in accordance with a first selection function; and
select between the measured output signal of the first photodetector and the measured output signal of the second photodetector in accordance with a second selection function.

17. The system as claimed in claim 15, wherein the first selection function and the second selection function are selected from a group consisting of:
a fixed threshold with hysteresis;
an adjustable threshold with hysteresis; and
a combination function.

18. The system as claimed in claim 1, wherein the at least one photodetector comprises:
a photodetector configured to convert detected pulses of optical photons over the intended incoming ionization radiation field range into output signal; and
the processing electronic measures the output signal by being configured to:
measure a magnitude of the photodetector’s detected pulses over measurement intervals determined by an adjustable threshold;
correct the measured magnitudes for temperature and amplitude dependent non-linearities in the scintillator;
sum the corrected magnitudes; and
convert the summed magnitude to dose rate by means of a scaling factor.

19. The system as claimed in claim 18, wherein the processing electronic are configured to:
determine the adjustable threshold as a function of one or more environmental variables affecting the photodetector’s performance: and
measure the magnitude of each of the photodetector’s detected pulse exceeding the adjustable threshold.

20. The system as claimed in claim 19, wherein the processing electronic is further configured to:
extend the measurement interval to include a first interval prior to the photodetector’s detected pulse exceeding the adjustable threshold and/or a second interval after the photodetector’s detected pulse falling below the adjustable threshold.

21. A method for measuring a dose rate of an ionizing radiation field comprising:
modifying the ionization radiation field passing through a compensation shield fully enclosing a scintillator to compensate for absorption efficiency and conversion efficiency of the scintillator;
converting optimally absorbed energy of the modified ionizing radiation field into optical photons by the scintillator;
converting the optical photons into an output signal by at least one photodetector; and
determining the dose rate in accordance with the output signal measured by a processing electronic.

22. The method as claimed in claim 21, further comprising:
displaying the determined dose rate, and/or storing the determined dose rate, and/or providing the determined dose rate for further processing by the processing electronic.

23. The method as claimed in claim 21, wherein the modifying the ionization radiation field comprises:
selectively absorbing the ionizing radiation in approximate inverse relationship to the scintillator’s energy absorption efficiency.

24. The method as claimed in claim 21, wherein the converting the optical photons into an output signal comprises:
converting a continuous stream of optical photons into an output signal; and
determining the dose rate in accordance with the output signal comprises:
correcting the output signal measurement for temperature and amplitude dependent non-linearities in the scintillator;
integrating the corrected signal over a pre-determined time interval; and
converting the integrated signal to dose rate by means of a scaling factor.

25. The method as claimed in claim 24, wherein the at least one photodetector is selected form a group of:
a photodiode;
a photomultiplier tube;
a silicon photomultiplier; and
an addressable pixelated optical image sensor.

26. The method as claimed in claim 21, wherein the converting the optical photons into an output signal by the at least one photodetector comprises:
optically coupling a first photodetector to the scintillator;
optically isolating a second photodetector from the scintillator; and
wherein measuring the output signal by the measuring electronic comprises:
receiving output signals from both photodetectors; and
subtracting the output signal from the second photodetector from the output signal from the first photodetector.

27. The method as claimed in claim 26, wherein the second photodetector’s parameters best match the first photodetector’s parameters.

28. The method as claimed in claim 21, wherein the converting the optical photons into an output signal by the at least one photodetector comprises:
optically coupling a first plurality of pixels of an addressable pixelated optical image sensor to the scintillator;
optically isolating a second plurality of pixels of the addressable pixelated optical image sensor to the scintillator; and
wherein measuring the output signal by the measuring electronic comprises:
receiving output signals from both the first plurality of the optically coupled pixels and the second plurality of the optically isolated pixels; and
subtracting the output signal from the second plurality of the optically isolated pixel from the output signal from the first plurality of the optically coupled pixels.

29. The method as claimed in claim 28, wherein measuring the output signal further comprises:
monitoring each pixel for a change of the pixel’s performance; and
excluding from the measuring the output signal of the pixels, the output signal of which fails to satisfy pre-determined criteria.

30. The method as claimed in claim 21, wherein the converting the optical photons into an output signal by the at least one photodetector comprises:
optically coupling a photodetector to the scintillator via an optical switch disposed between the photodetector and the scintillator; and
wherein the measuring the output signal by the measuring electronic comprises:
causing the optical switch to optically uncouple the photodetector from the scintillator for a first time interval; and
subtracting the photodetector’s output signal measured during the first time interval from the photodetector’s output signal measured during a coupled second time interval.

31. The method as claimed in claim 21, further comprising:
operating a single photodetector over the range of the ionizing radiation field; and
measuring the output signal by the measuring electronic comprises:
measuring an output signal of the photodetector in a pulse-counting with magnitude mode over a first sub-range;
measuring the output signal of the photodetector in a current mode over a second sub-range; wherein the two sub-ranges partially overlap; and
selecting between the measured output signals in the partial overlap.

32. The method as claimed in claim 31, wherein the selecting between the measuring the output signals in the partial overlap comprises:
determining a threshold in accordance with characteristics of the photodetector in the partial overlap;
determining a hysteresis in accordance with the dose rate specified by the design parameters and required system response time; and
selecting between the measured output signals of the photodetector in the partial overlap in accordance with the threshold and the hysteresis.

33. The method as claimed in claim 31, wherein the selecting between the measuring the output signals in the partial overlap comprises:
determining a threshold in accordance with characteristics of the photodetector in the partial overlap;
determining a hysteresis in accordance with the dose rate specified by the design parameters and required system response time;
dynamically adjusting the determined threshold in accordance with the characteristics to keep dose rate specified by the design parameters within the design parameters of the system; and
selecting between the measured output signals of the photodetector in the partial overlap in accordance with the threshold and the hysteresis.

34. The method as claimed in claim 31, wherein the selecting between the measured output signals in the partial overlap comprises:
determining relative contribution of each measured output signal of the photodetector in the partial overlap so that the error of the resulting output signal is within the design criteria; and
combining the measured output signals in the partial overlap in accordance with the relative contribution.

35. The method as claimed in claim 21, further comprising:
operating a first photodetector over a first sub-range of the ionizing radiation field;
operating a second photodetector over a second sub-range of the ionizing radiation field wherein the two subranges partially overlap;
measuring the output signal by the measuring electronic comprises:
measuring an output signal of the first photodetector in a first mode over a first section of the first sub-range;
measuring the output signal of the first photodetector in a second mode over a second section of the first sub-range;
measuring an output signal of the second photodetector over the second sub-range; and
selecting among the measured output signals.

36. The method as claimed in claim 35, wherein the selecting among the measured output signals comprises:
selecting between the measured output signal of the first photodetector in the first mode over the first section of the first sub-range and the measured output signal of the first photodetector in the second mode over the second section of the first sub-range in accordance with a first selection function; and
selecting between the measured output signal of the first photodetector and the measured output signal of the second photodetector in accordance with a second selection function.

37. The method as claimed in claim 35, wherein the first selection function and the second selection function are selected from a group consisting of:
a fixed threshold with hysteresis;
an adjustable threshold with hysteresis; and
a combination function.

38. The method as claimed in claim 21, wherein the determining the dose rate in accordance with the measured output signal comprises:
converting pulses of optical photons detected over the intended incoming ionization radiation field range to an output signal by a photodetector;
measuring a magnitude of each of the photodetector’s detected pulse over a measurement interval determined by an adjustable threshold;
correcting the measured magnitudes for temperature and amplitude dependent non-linearities in the scintillator;
summing the corrected magnitudes; and
converting the summed magnitude to dose rate by means of a scaling factor.

39. The method as claimed in claim 38, wherein the measuring a magnitude of each of the photodetector’s detected pulse over a measurement interval comprises:
determining the adjustable threshold as a function of one or more environmental variables affecting the photodetector’s performance: and
measuring the magnitude of each of the photodetector’s detected pulse exceeding the adjustable threshold.

40. The method as claimed in claim 39, wherein the comprises:
extending the measurement interval to include a first interval prior to the photodetector’s detected pulse exceeding the adjustable threshold and/or a second interval after the photodetector’s detected pulse falling below the adjustable threshold.
